(19) United States
(12) Patent Application Publication
(10) Pub. No.: US 2026/0180046 A1
(43) Pub. Date: Jun. 25, 2026

(54) Method for Operating an Energy Source

(71) Applicant: Viessmann Climate Solutions SE, Allendorf (DE)

(72) Inventor: Christoph SAGEWKA, Dorsten (DE)

(21) Appl. No.: 18/728,884

(22) PCT Filed: Jan. 18, 2023
(86) PCT No.: PCT/EP2023/051090

§ 371 Date: Jul. 14, 2024

(30) Foreign Application Priority Data
Jan. 25, 2022 (DE) 10 2022 101 709.5

(51) Int. Cl. H01M 10/44; H01M 10/42; H01M 10/48

(52) U.S. Cl. CPC H01M 10/44; H01M 10/425; H01M 10/441; H01M 10/48; H01M 10/486

(57) ABSTRACT

A method for operating an energy source at an installation location comprises a step of acquiring a plurality of data records of a plurality of identical energy sources, wherein each data record comprises a plurality of temperature measured values. In a further step, a data record of an individual energy source is selected from the plurality of identical energy sources and a calculation is performed. In a step of the calculation, the plurality of data records are statistically evaluated and a thermal model which describes a thermal interaction between the energy sources and the respective installation location is generated. The data record of the individual energy source is compared with the thermal model and a deviation is determined. A signal is output depending on the determined deviation.

The present invention relates to a method for operating an energy source at an installation location in a building, wherein the energy source is provided for supplying the building with energy. In particular, a thermal model is to be generated which describes a thermal interaction between the energy source and the installation location in the building.

The growing proportion of renewable energies, such as electricity from wind power or solar energy, means that at certain times electricity from such regenerative sources is available in abundance, while at other times fossil-fueled peak-load power plants have to generate electricity with emissions. Since the storage of electrical energy is associated with many technical hurdles, the need has arisen to control consumption by end consumers in accordance with the availability of electrical energy in the grid, so that increased consumption can be brought about at peak loads and lower consumption at off-peak times.

The situation is similar in buildings (e.g., residential buildings or commercial buildings) with decentralized energy sources, such as a fuel cell, a photovoltaic system (PV system) or other energy sources which, for example, supply electrical power. Here, it is often desirable to consume or store locally generated energy locally and to minimize the purchase of energy from a public supply network. Battery storage systems are generally used to store locally generated electrical energy, which store energy when there is an oversupply of locally generated electricity and release it again when required by local consumers.

A storage system with which electrical energy can be fed into and taken from an electricity grid is disclosed, for example, by DE 10 2010 001 874 A1. The storage system described therein comprises a control unit with which the output to the electricity grid and the intake of energy from the electricity grid are controlled. With such a storage system, energy can be taken up in times of oversupply and released again in times of increased demand. Accordingly, the storage system can also be used, for example, to smooth voltage peaks or voltage troughs.

Such a battery storage system for a building is an example of an energy source within the meaning of the present invention. Particularly in the case of battery storage systems, but also in the case of other energy sources within the meaning of the invention, it is important to know or predict an internal temperature or operating temperature, since a deviation of the operating temperature from an optimum temperature range can lead to a reduction in the performance of the energy source. However, since the ambient conditions of the energy source are generally not known sufficiently, it is difficult to make predictions about the operating temperature of the energy source.

The object of the present invention is to provide an improved method for operating an energy source at an installation location, which solves the problems mentioned above. According to a first aspect of the invention, the object is achieved by a method according to claim 1. Further aspects of the invention emerge from the subclaims, the figures and the following description of exemplary embodiments.

In the present description, the terms energy and power are used synonymously in part. It is understood by the person skilled in the art that a power consumption means an energy consumption per time, and that a certain energy consumption can be regarded as an integrated power consumption over a certain period of time.

An energy source within the meaning of the invention is an energy-related terminal device or a device which provides energy to a building, for example in the form of electrical energy and/or heat and/or cold. In particular, the energy source can be a battery storage system for a building, which stores electrical energy and can output it to an electricity grid in the building for supplying consumers. However, an energy source within the meaning of the invention can also be a local energy generator, such as a fuel cell, a heat pump or a heat generator, such as a condensing boiler, a combined heat and power plant or the like, this enumeration being neither to be understood as limiting nor as exhaustive.

If reference is made below to “an energy source” or “the energy source”, this may mean at least one energy storage system and/or at least one energy generator. The at least one energy source can be part of an energy system which further comprises an internal electricity grid, at least one consumer connected to the internal electricity grid, a grid connection point and a control device.

If the present description or the claims refer to a “user and/or operator” of the energy source, this may mean, for example, an end customer, an installer, a service technician or the like.

An installation location of such an energy source is often in a basement of a building. Other installation locations are also possible. The exact geometry, thermal conductivity, further heat sources, influence of the outside temperature and the like are often not known exactly or difficult to determine, so that it would generally be very complex to adequately calculate and/or model thermodynamic properties of the installation location. It is therefore an object of the present invention to provide a method for carrying out a qualitative and/or quantitative assessment of the installation location with regard to the thermodynamic properties. The purpose of this is in particular to avoid a reduction in the performance of the energy source, for example an effect referred to as thermal derating in the case of battery storage systems.

An installation location can be assessed, for example, on the basis of an average room temperature. Further criteria include, for example, a possible heat output to the surroundings. Such properties can depend on many parameters, such as the geometric conditions, including a distance to walls and a ceiling of the room, the material of the walls and ceiling, the surface quality of the walls and ceiling, etc.

Different energy sources operate with different efficiencies at different temperatures. In addition, aging of the energy source can depend on an internal temperature or an external temperature. It is therefore important to be able to calculate relationships between internal temperature or external temperature and a power output of the energy source. If the energy source is operated under optimum conditions, resources and costs can also be saved.

Each energy source also generates heat to some extent and interacts with its surroundings at the installation location. Heat can be transferred by radiation, heat conduction and/or convection. These processes depend on a large number of parameters, including thermal conductivity coefficients, geometry of the surroundings, temperature of the surroundings, etc. Due to the large number of variables alone, it is difficult to generate a thermal model for an installation location from scratch.

According to the invention, a thermal model is to be generated which describes a thermal interaction between a considered energy source and its installation location. For this purpose, a plurality of data records of a plurality of identical energy sources are recorded and statistically evaluated. Each data record can comprise a plurality of temperature measured values, which are measured, for example, by a plurality of temperature sensors at a plurality of different positions on and in a housing of the energy source. In other words, a big data analysis of measured values of a plurality of devices in operation is to be carried out in order to determine the thermal influence of the surroundings or the installation location.

In order to generate the thermal model, a statistical evaluation of the plurality of data records is carried out. For example, a regression analysis can be carried out. In particular, the statistical evaluation can comprise carrying out a linear regression. On the basis of the generated thermal model, the installation location of an individual energy source can then be assessed. For this purpose, data records of the individual energy source are compared with the thermal model and a deviation is determined. A signal can be output depending on the deviation.

Preferably, each data record can comprise a time course of an internal temperature of the respective energy source and a time course of an external temperature of the respective energy source. The terms internal temperature and external temperature can be understood, for example, relative to a housing of the energy source. In particular, an internal temperature is measured at at least one position in a battery stack of a battery storage system. The external temperature is preferably measured on or near the housing. A temperature measured on an inside of a housing can also be referred to as the external temperature. Measuring on the inside has the advantage that the corresponding temperature sensor can be arranged inside the housing, protected from external influences. Alternatively, the external temperature can be measured on an outside of the housing. If the housing is made of a thin sheet metal, for example, the difference between a measurement on the inside and a measurement on the outside can be very small or negligible.

The data records can be evaluated as a function of the internal temperature and the external temperature. If measured values for the internal temperature and the external temperature are available, a temperature gradient from the inside to the outside can in particular be determined. For example, it can be determined whether the surroundings of the energy source can bring about cooling, or how efficient the effect of cooling is.

Preferably, each data record comprises geographical information and/or weather information of the installation location. The geographical information can be stored in the data record, for example, as GPS coordinates or the like. The geographical information serves in particular to select a group of identical energy sources in similar climatic conditions, so that the thermal model is as accurate as possible for all energy sources, since external parameters of the surroundings of the building, such as an external temperature of the building, can also have an influence on the temperature in and/or on the energy source. The geographical information can preferably also comprise a geodetic height.

Weather information can also preferably be used to select data records with similar climatic conditions for generating the thermal model. The data records can then be evaluated accordingly as a function of the geographical information and/or the weather information.

The thermal model preferably describes a heat transfer resistance of the energy source and/or a heat transfer coefficient of the energy source and/or a heat capacity of the energy source. These parameters can describe the thermodynamic interaction of the energy source with the installation location and advantageously make it possible to predict the internal temperature of the energy source as a function of an output and/or absorbed power.

Generating a thermal model for a single energy source is very complex and can only describe the daily profile of a single system. Only by evaluating a large number of data records of a large number of identical energy sources with different boundary conditions does it become possible to generate a parameterized thermal model under all operating conditions. Average model parameters for starting values of the parameter identification of the energy source can be generated by means of the least squares method.

Without knowledge of the behavior of other energy sources, in particular of energy sources of different ages, no conclusions can be drawn about the energy source under consideration. The different ages of the energy sources allow, for example, the service life, battery aging, etc. to be taken into account during the evaluation.

Evaluating a large number of data records also makes it possible to identify geographical conditions. Energy sources in different geographical regions are operated under different ambient conditions, for example due to different weather and climate conditions. Such deviations can also only be identified by evaluating a large amount of data records from a large number of energy sources.

In a preferred embodiment, the energy sources are each battery storage systems for storing and providing electrical energy in a household. Accordingly, the external temperature is preferably measured in each case by a sensor on a housing of the battery storage system. The internal temperature is preferably measured in each case by a plurality of sensors inside the battery storage system.

Preferably, each data record comprises a time course of a respective output power of the energy source, in particular an electrical power of the energy source. Accordingly, the data records can be evaluated as a function of the output electrical power. Since the power output of the energy source can be reduced as a function of an operating temperature of the energy source, in particular in relation to an optimum range of the operating temperature, for example by a control device of the energy source, the measured power output is a good indicator of a course of the operating temperature. Thus, a thermal model could even be generated without measuring temperature values. If both temperature measured values and power measured values are available, it is possible to draw conclusions about properties such as the heat transfer resistance of the energy source and/or the heat transfer coefficient of the energy source and/or the heat capacity of the energy source.

Preferably, the thermal model describes a dependence of a state of charge and/or a battery aging of the battery storage system on the internal temperature and/or the external temperature. The aim of the method is to prevent a decrease in the performance of the battery storage system. This means that the operation of the battery storage system is preferably controlled in such a way that the internal temperature and/or the external temperature remain in a range which has no or the smallest possible negative effect on the state of charge and/or the battery aging of the battery storage system.

The output of the signal can be effected in various ways. In particular, the signal can be transmitted in the form of a message to a terminal device of a user and/or operator of the energy source. Additionally or alternatively, the signal can be displayed as an indication on a display device on the energy source or near the energy source. Further additionally or alternatively, the signal can be a control signal or actuating signal which is output by a control device of the energy source or a control device of an energy system of the building to the energy source, in particular in order to carry out a control intervention.

Preferably, the output signal can comprise at least one instruction to reduce a maximum output power of the individual battery storage system. This can in particular reduce the internal temperature and/or the external temperature of the energy source, or a further increase can be avoided. In particular, it is avoided that the internal temperature and/or the external temperature of the energy source rise above a predetermined limit temperature. Thus, a power loss due to an excessively high temperature can be prevented. The reduced maximum output power can advantageously be greater than an output power of the battery storage system limited due to an excessively high temperature.

An early preventive power reduction of the energy source, in particular of the energy storage system, as described above, can advantageously lead to higher energy storage or to a higher energy transfer over a considered period of time, compared to a case in which no preventive power reduction is carried out. In conventional methods, the power reduction is not carried out until a limit temperature is reached, so that the power reduction is then more drastic compared to the method of the present invention. The same or similar method steps can be implemented accordingly for a different type of energy source, such as a fuel cell or a heat pump.

Preferably, the output signal can comprise an error message to a user and/or operator of the battery storage system. In particular, the error message can be output to a mobile terminal device of the user and/or operator.

Preferably, the output signal can comprise a recommendation for action to the user and/or operator of the battery storage system. Possible actions are, for example: If the room temperature at the installation location is too high for optimum operation of the battery storage system, a request to reduce the room temperature by a certain value can be output. Correspondingly, if the room temperature at the installation location is too low for optimum operation of the battery storage system, a request to increase the room temperature by a certain value can be output. If thermal barriers are detected in the immediate vicinity of the battery storage system, a request can be output to free the closer surroundings of the battery storage system from negative influences. Possible causes of a negative influence can be, for example, other energy sources, pieces of furniture such as cupboards or the like, stored goods, etc. If it is detected that the room temperature at the installation location is too low at certain times between fixed times of day, a request can be output to increase the room temperature for optimum operation of the battery storage system in this period by a few degrees Celsius.

Preferably, the output signal can comprise at least one instruction to carry out a control intervention on the individual energy source. Possible control interventions include a reduction in the power of the energy source. The instruction can in particular be output to a control device of the energy source, which can adjust the control of the operating state of the energy source accordingly.

In a preferred embodiment, the method comprises a step of calculating a prediction of a data record of the individual energy source for a predetermined period of time. In a further step, an actual data record of the predetermined period of time is recorded. Subsequently, the predicted data record is compared with the actual data record and a deviation can be determined. The thermal model can be adapted depending on the determined deviation. In this way, the thermal model for the individual energy source can be iteratively improved so that more accurate predictions can be made. Preferably, these method steps can be repeated regularly in order to further improve the thermal model.

According to a preferred embodiment, the method comprises a step of transmitting the plurality of data records of the plurality of identical energy sources to a cloud or a server. The cloud or the server can be arranged geographically remotely from the plurality of energy sources. The data records can be stored in the cloud or in a storage device of the server in order to be used for an evaluation. The cloud or the server can evaluate the data records, wherein the calculations described above can be carried out.

The advantage of a cloud or a server which is connected to the plurality of energy sources in terms of communication via a network and suitable interfaces is that data from a large number of energy sources, which can be set up at a wide variety of locations, can be received and evaluated. Furthermore, method steps of the evaluation and the calculations carried out with the data can be adapted centrally.

Depending on the results of the calculations, a signal can be output by the cloud or the server, for example to a mobile terminal device of a user or operator of the energy source. The mobile terminal device can receive the signal in particular via an internet connection.

Each energy source can be connected to a network via a suitable interface, for example via a gateway to the internet, and can transmit data records to a server or a cloud or receive them from the server or the cloud. This can enable remote control, remote maintenance, remote analysis, etc. of the energy source. In addition, computationally intensive processes (e.g., machine learning algorithms) and/or the storage of large amounts of data can be outsourced to a server, a computer cluster or a cloud. Furthermore, it can be possible to transmit data records via a communication network, for example a mobile radio network, a telephone network, an intranet and/or the internet.

### BRIEF DESCRIPTION OF THE FIGURES

Further advantageous embodiments are described in more detail below with reference to an exemplary embodiment illustrated in the drawings, to which the invention is not, however, restricted.

The figures show schematically:

FIG. 1: FIG. 1 illustrates a building with an energy system.

FIG. 2: FIG. 2 illustrates a method according to an exemplary embodiment of the invention.

### DETAILED DESCRIPTION OF THE INVENTION WITH REFERENCE TO EXEMPLARY EMBODIMENTS

In the following description of a preferred embodiment of the present invention, the same reference numerals denote the same or comparable components.

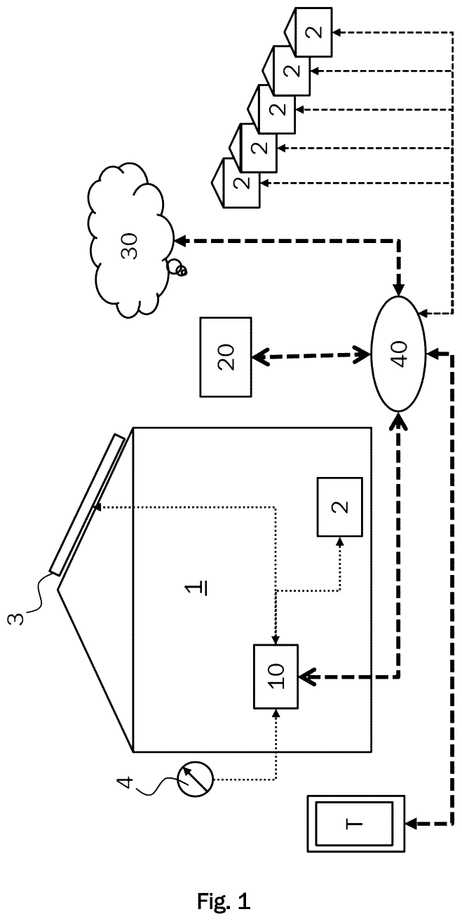

FIG. 1 shows a simplified schematic representation of an exemplary embodiment of an energy system 1 in a building. The building can in particular be a residential building or an office building. The energy system 1 shown in FIG. 1 comprises, as a first energy source for electrical power, a photovoltaic system 3 (hereinafter also abbreviated as PV system), which converts radiation energy from the sun into electrical energy. Instead of a PV system or in addition to the PV system 3, the energy system 1 can have other (renewable) energy sources, such as, for example, a wind turbine, a fuel cell, a heat pump, a combined heat and power plant and/or a condensing boiler.

An inverter (not shown) converts the direct current generated by the PV system 3 into alternating current and feeds it into an internal electricity grid (not shown) of the building. A plurality of consumers (not shown) which consume electrical energy can be connected to the internal electricity grid. Furthermore, at least one battery storage system is connected to the electricity grid as energy source 2. The battery storage system 2 can store, for example, electrical energy generated by the PV system 2 or taken from a public electricity grid.

The battery storage system 2 comprises an inverter which can convert alternating current from the public electricity grid into direct current for charging the battery storage system 2. Furthermore, the inverter can convert direct current from the battery storage system 2 into alternating current for the internal electricity grid in the building. A direct power line (not shown) can also be provided between PV system 3 and battery storage system 2 for charging the battery storage system 2 with energy from the PV system 3, so that conversion between direct current and alternating current can be omitted when charging the battery storage system 2.

The energy system 1 further comprises a control device 10 for regulating and/or controlling the PV system 3, or the inverter of the PV system 3, and for regulating and/or controlling the battery storage system 2, or the inverter of the battery storage system. Dashed arrows in FIG. 1 illustrate signal lines for control and/or actuating signals or measuring signals from sensors and the like.

The energy system 1 comprises an external temperature sensor 4 for measuring an external temperature of the building. Furthermore, a plurality of temperature sensors can be arranged in the battery storage system 2. The control device 10 acquires the measuring signals of the temperature sensors and regularly generates data records which, for example, contain current temperature measured values and current power values of the energy sources 2, 3. The control device 10 transmits the data records regularly to a cloud 30 and/or a server 20 via a suitable communication interface. The data records are transmitted via a suitable network 40, which can be, for example, the internet. Furthermore, a terminal device T of a user or operator of the energy system 1 can communicate with the network 40.

Furthermore, a plurality of other buildings, which can be geographically remote from one another, are illustrated in FIG. 1. Each of these buildings comprises an energy system with an identical battery storage system 2 as energy source. Furthermore, each energy system in these buildings comprises a control device which transmits data records of the battery storage system 2 to the network 40. Thus, the cloud 30 and/or the server 20 can acquire and evaluate a plurality of data records of a plurality of identical energy sources 2.

An exemplary embodiment of a method according to the invention, which can be carried out in an energy system 1 as illustrated in FIG. 1, will now be described.

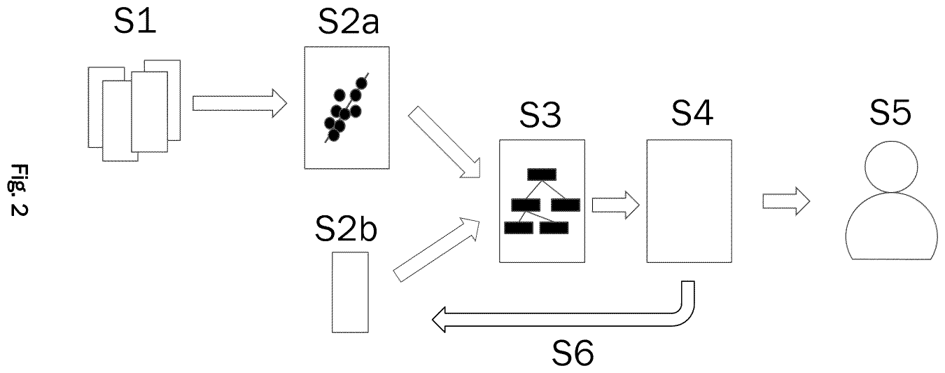

FIG. 2 illustrates a method according to an exemplary embodiment of the invention. In a first step S1 of the method, a cloud 30 (or a server 20) acquires a plurality of data records of a plurality of identical energy sources 2 via a network 40. The energy sources 2 can be arranged geographically remotely from one another in different buildings. Each energy source 2 is in particular connected to a control device 10, which in each case outputs data records to the network 40.

In a subsequent step S2a, a statistical evaluation of the plurality of data records of the plurality of energy sources is carried out and a thermal model which describes a thermal interaction between the energy sources and the respective installation location is generated. In step S2b, one of the plurality of energy sources is selected.

In particular, a dynamic thermal model can be generated from the plurality of data records of all the acquired energy sources. Preferably, a heat transfer resistance, a heat transfer coefficient and a heat capacity of the components of the energy source are calculated on the basis of a linear regression of the data records.

A general thermal model preferably makes it possible to determine the thermal properties of internal components of one of the plurality of energy sources. In particular, the thermal model can describe the following quantities: thermal parameters of an inverter of a battery storage system as energy source, thermal parameters of the battery as a function of the state of charge, the battery temperature and the battery aging, including resistance and capacity loss, and thermal parameters of the housing of the battery storage system.

When generating the thermal model, ambient conditions of the respective geographical location can preferably be taken into account. For example, thermal parameters of the average surroundings can be taken into account. Furthermore, weather data can in each case be included when generating the model. The weather data can comprise, for example, an external temperature of the building. This is advantageous since the ambient conditions of the energy source in the room can be strongly influenced by high or low external temperatures. Furthermore, weather data relating to solar irradiation can be taken into account. For example, high irradiation can lead to higher power loss through an inverter of a PV system.

Before generating the thermal model, a subset of data records can preferably be selected on the basis of predetermined criteria in order to improve the accuracy of the thermal model for the selected energy source. In order to facilitate this process, the data records can preferably be sorted on the basis of the geographical location of the respective energy sources. The generated thermal model makes it possible in particular to determine a heat transfer coefficient of the convection and the heat radiation from the linear regression of the data records. In particular, a geographical model can be generated on the basis of the geographical location data. A geographical model is thus a thermal model which has been generated as a function of the geographical location data. An average model is, for example, a thermal model which can be generated by averaging all the geographical models.

In the next step S3, a data record of the selected energy source is compared with the thermal model. The installation location of the selected energy source can be assessed with regard to its thermal properties on the basis of a decision tree. Details of the decision tree are described further below.

In step S4, a deviation of the data record of the selected energy source from the thermal model is determined. A plurality of optimized control parameters for operating the energy source can be determined depending on the deviation.

The average model described above can preferably be compared with the geographically associated model with the energy source under consideration. Excessively large deviations can be identified here by analyzing data records from several days. Furthermore, suspected deviations can be identified by predictive calculations and comparison of the prediction with the actual stationary and dynamic behavior of the energy source.

In the following, deviations of the prediction or the actual data records from the thermal model can be assessed by comparing the model parameters of the energy source under consideration. Here, possible reasons for the determined deviation are to be determined in particular. A frequency of occurrence of deviations can be used in the following as a criterion for decisions (for example on the basis of a decision tree).

In steps S5 and S6, a signal is generated and output in each case depending on the determined deviation. In step S5, a message, in particular an error message, is output to a user and/or an operator of the energy source. The message can be output, for example, by transmitting the message to a mobile terminal device T of the user and/or operator.

The message transmitted to the user and/or an operator of the energy source can preferably comprise suggestions for optimizing the energy system. For example, time restrictions of the battery power and/or the state of charge can be suggested. The suggestions serve in particular to optimize the operation of the energy source in such a way that an impairment of the power output of the energy source can be minimized.

In step S6, the optimized control parameters can be transmitted by the cloud 30 or the server 20 to the control device 10 of the energy source 2 via the network 40. This transmission of optimized control parameters is also referred to as a “control intervention”. Exemplary control interventions include a permanent or partial derating of the battery power and/or an optimization of a derating of a PV system.

A possible decision tree in step S3 will now be described. The following example relates to an energy system as in FIG. 1 with a battery storage system 2 and a PV system 3, which charges the battery storage system 2.

On the basis of the data records of an individual energy source, for example a battery storage system 2, the server 20 (or the cloud 30) can detect, for example, that the battery could not be charged or discharged optimally in the course of the day and specifically in the evening hours due to thermal derating and that the battery required longer downtimes at night compared to other energy sources (other battery storage systems in other buildings) in order to cool down again to an ambient temperature of the energy source. The plurality of temperature sensors in the battery storage system 2 measured, for example, an increased surface temperature of the housing compared to corresponding temperature sensors of other, geographically similarly located, battery storage systems. A deviation in the data records of the battery storage system 2 under consideration from other identical battery storage systems was thus detected.

To simplify the present example, a possible deviation of the temperatures due to properties of the battery is excluded (for example, non-ideal thermal behavior due to aging of the batteries of the battery storage system and the like).

The determination of the deviations can now be analyzed on the basis of the thermal model and the data records of the energy source under consideration.

From the calculations of the thermal model in combination with the power data of the PV system 3, a significantly increased battery temperature can be detected in the case of high solar irradiation (weather data and measured PV power)-but only a moderately increased temperature on days with moderate irradiation. A comparison of the battery powers of the system on the different days shows that the battery storage system 2 was charged with the same average battery power in both cases.

As a result, it is assumed that the temperature increase is primarily caused by a higher inverter power loss of the PV system 3 and that the PV inverter could be arranged in the immediate vicinity of the battery storage system 2. Depending on the operating mode and setting of the inverter, several possible control interventions can already result from this. For example, the emitted heat loss of the PV system 3 can be reduced by means of an adaptation of the dynamic PV derating, i.e. reducing the feed-in power of the inverter (active power limitation). The possible and necessary active power limitation is analyzed here with the data records of the PV system 3 and the battery storage system 2 and only reduced to such an extent that, despite a possibly lower PV yield, a higher self-consumption compensation of the building is achieved by grid feed-in or battery charging power.

The terms dynamic PV derating and active power limitation come from solar technology. They refer, for example, to a 70% regulation, which reduces the PV feed-in power into the grid to 70% of the installed maximum PV power according to the EEG (Renewable Energy Sources Act). In the case of dynamic active power limitation, only these 70% would then be fed into the grid in the event of an impending maximum PV power, and the remaining 30% would flow into the battery storage system, i.e. from the point of view of the PV system, 100% of the solar energy generated would be used.

In the present example, the adaptation could mean that the PV system is set to a dynamic 60% active power limitation, so that 60% is fed in and the remainder is stored in the battery. By reducing the power consumption of the battery storage system 2, it is thus possible, for example, to ensure that the PV system generates less heat loss.

However, if a similar excessive temperature increase is measured on two days under consideration with the same battery power (day with high solar irradiation and day with medium solar irradiation), then a poor heat dissipation of the battery storage system 2 to the surroundings could initially be suspected. If the maximum temperature is different on the two days, the analysis of the daily profiles must be continued.

If the data records also show a deviation in the cooling of the battery storage system 2 in the late evening hours and the night and in comparison to other battery storage systems and the thermal model, it follows that the dynamic thermal behavior is also a carrier at lower battery temperatures, both in the comparison result between the day with high solar irradiation and the day with medium solar irradiation in the evening hours and in comparison to other battery storage systems.

Then, by calculating the thermal model with the thermal data of the battery storage system 2 and the powers of the daily profiles of the PV system 3, it can be concluded that there is an increased thermal resistance between the surroundings of the battery storage system and a surface temperature of a housing of the battery storage system. If, in addition, a deviation is mostly observed at night, it can also be concluded that there is another device near the battery storage system which switches on at night.

A comparison of data records at high and low external temperatures of the building could show, for example, that a deviation occurs primarily when low external temperatures prevail. It can be concluded from this that a heating boiler or the like is located near the installation location of the battery storage system 2, which influences the battery storage system.

For example, the data records could show that the energy system 1 cannot be operated with optimum efficiency on very sunny autumn or winter days because high PV power heats up the battery storage system during charging and the heating boiler switched on in the evening hours heats up the housing surface of the battery storage system 2. Depending on the frequency of the deviation, a maximum battery power could be reduced or PV derating could be implemented. Depending on whether further deviations are detected (e.g. excessive surface temperature on days without use of the battery storage system or on days with excessive use of the battery storage system), the information regarding the interaction with the heating boiler at the installation location can be output to the user or operator or the parameters PV power and battery power can be adapted via a control intervention.

The features disclosed in the foregoing description, the claims and the drawings can be of significance both individually and in any combination for realizing the invention in its various embodiments.

1. A method for operating an energy source (2) at an installation location, comprising the steps of:
acquiring a plurality of data records of a plurality of identical energy sources (2), wherein
each data record comprises a plurality of temperature measured values;
selecting a data record of an individual energy source (2) from the plurality of identical energy sources;
performing a calculation, comprising the steps of:
statistically evaluating the plurality of data records and generating a thermal model which describes a thermal interaction between the energy sources and the respective installation location; and
comparing the data record of the individual energy source (2) with the thermal model and determining a deviation; and
outputting a signal depending on the deviation.

2. A method according to claim 1, wherein
each data record comprises a time course of an internal temperature of the respective energy source (2) and a time course of an external temperature of the respective energy source (2); and
the data records are evaluated as a function of the internal temperature and the external temperature.

3. A method according to claim 2, wherein
the external temperature is measured on an inside or on an outside of a housing of the energy source (2).

4. A method according to claim 1, wherein
each data record comprises geographical information and/or weather information of the installation location; and
the data records are evaluated as a function of the geographical information and/or the weather information.

5. A method according to claim 1, wherein
the statistical evaluation comprises carrying out a linear regression.

6. A method according to claim 1 according to any one of the preceding claims, wherein
the thermal model describes a heat transfer resistance of the energy source (2) and/or a heat transfer coefficient of the energy source (2) and/or a heat capacity of the energy source (2).

7. A method according to claim 2, wherein
the energy sources (2) are each battery storage systems for storing and providing electrical energy in a household;
the external temperature is in each case measured by a sensor on a housing of the battery storage system (2); and
the internal temperature is in each case measured by a plurality of sensors inside the battery storage system (2).

8. A method according to claim 7, wherein
each data record comprises a time course of an output electrical power; and
the data records are evaluated as a function of the output electrical power.

9. A method according to claim 7, wherein
the thermal model describes a dependence of a state of charge and/or a battery aging of the battery storage system (2) on the internal temperature and/or the external temperature.

10. A method according to claim Z, wherein
the output signal comprises
at least one instruction to reduce a maximum output power of the battery storage system (2); and/or
an error message to a user and/or operator of the battery storage system; and/or
a recommendation for action to the user and/or operator of the battery storage system (2).

11. A method according to claim 1, further comprising:
calculating a prediction of a data record of the individual energy source (2) for a predetermined period of time;
acquiring an actual data record of the predetermined period of time;
comparing the predicted data record with the actual data record and determining a deviation; and
adapting the thermal model depending on the deviation.

12. A method according to claim 1, further comprising:
transmitting the plurality of data records of the plurality of identical energy sources to a cloud (30) or a server (20);
performing the calculation in the cloud (30) or by the server (20); and
outputting a signal by the cloud (30) or the server (20).

13. A method according claim 1, wherein
the output signal comprises:
at least one instruction to carry out a control intervention on the individual energy source (2).
